(19) United States
(12) Patent Application Publication
(10) Pub. No.: US 2005/0219173 A1
(43) Pub. Date: Oct. 6, 2005

(54) Pixel loading and display

(76) Inventors: Wiatt E. Kettle, Corvallis, OR (US); Adam Ghozeil, Corvallis, OR (US); Eric Martin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/129,995

(22) Filed: May 16, 2005

Related U.S. Application Data
(63) Continuation-in-part of application No. 10/734,685, filed on Dec. 12, 2003.

(51) Int. Cl. G09G 3/34

(52) U.S. Cl. 345/84; 345/87

(57) ABSTRACT

An embodiment provides for loading a first data bit intended for a first portion of a pixel array and displaying the first data bit on the first portion of the pixel array for at least a portion of its total display time before loading a second data bit intended for a second portion of the pixel array.

### CROSS REFERENCE TO RELATED APPLICATIONS

This application is a Continuation-in-Part of U.S. application Ser. No. 10/734,685, filed Dec. 12, 2003, which application is incorporated herein by reference.

### BACKGROUND

Data is often loaded from top to bottom on many pulse-modulated micro-displays using continuous rastering. However, this often involves high average data rates and may involve decoupling pixel activation from the data loading.

### DESCRIPTION OF THE DRAWINGS

FIG. 1 is an embodiment of a projector, according to an embodiment of the present disclosure.

FIG. 2 illustrates an embodiment of loading data, according to an embodiment of the present disclosure.

FIG. 3 shows an embodiment pixel states, according to another embodiment of the present disclosure.

FIG. 4 illustrates another embodiment of loading data, according to another embodiment of the present disclosure.

FIG. 5 illustrates an embodiment of scheduling data loading and display, according to another embodiment of the present disclosure.

### DETAILED DESCRIPTION

In the following detailed description of the present embodiments, reference is made to the accompanying drawings that form a part hereof, and in which is shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

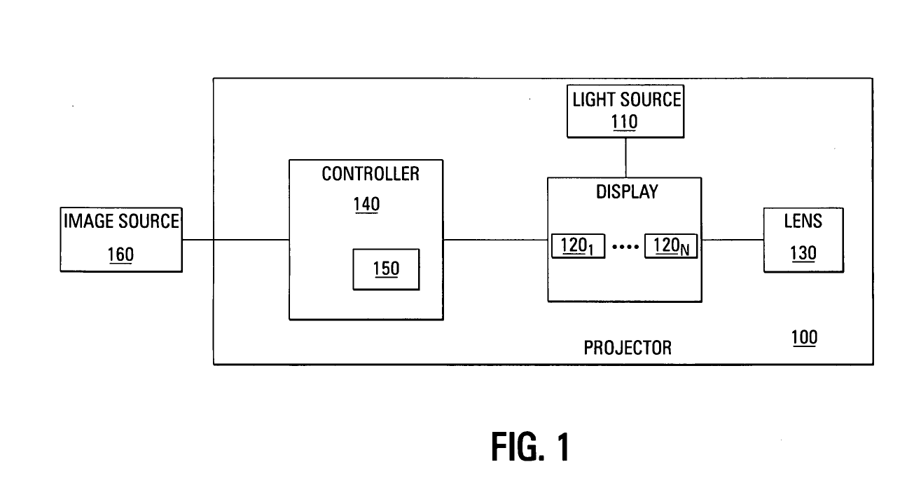

FIG. 1 is a block diagram of a digital projector 100, such as is used in rear or front projection systems, according to an embodiment. Digital projector 100 includes a light source 110, micro-displays 120 optically coupled to light source 110, and a projection lens 130 optically coupled to micro-displays 120. Micro-displays 120 receive light from light source 110, and projection lens 130 magnifies micro-displays 120. Each of micro-displays 120 includes an array of pixels, and for one embodiment, the array has row-addressable loading. When the pixels of a micro-display 120 are ON, the pixels direct the light to projection lens 130. When the pixels are OFF, they produce a “black” state. For another embodiment, micro-displays 120 are pulse modulated.

Projector 100 also includes a controller 140 for controlling the operation of micro-displays 120. For one embodiment, controller 140 controls the modulation of micro-displays 120. For another embodiment, controller 140 is adapted to perform methods in accordance with embodiments of the present disclosure in response to computer-readable instructions. These computer-readable instructions are stored on a computer-usable media 150 of controller 140 and may be in the form of software, firmware, or hardware. In a hardware solution, the instructions are hard coded as part of a processor, e.g., an application-specific integrated circuit (ASIC) chip, a field programmable gate array (FPGA), etc. In a software or firmware solution, the instructions are stored for retrieval by controller 140. Some additional examples of computer-usable media include static or dynamic random access memory (SRAM or DRAM), read-only memory (ROM), electrically-erasable programmable ROM (EEPROM or flash memory), magnetic media and optical media, whether permanent or removable.

Controller 140 receives digital source data, for example, from an image source 160, such as a computer, DVD player, a set-top box connected to a direct television satellite link, or a cable television provider, etc. For some embodiments, controller 140 formats the digital data in a multiple bit format, such as an eight bit per color format, e.g., eight bits for each of the colors red, green, and blue. Each of the micro-displays 120 displays one bit of data on each of its pixels. That is, when the level of a bit is a logic HIGH, for example, the pixel is ON or active, and when the level of a bit is a logic LOW, the pixel is OFF or inactive.

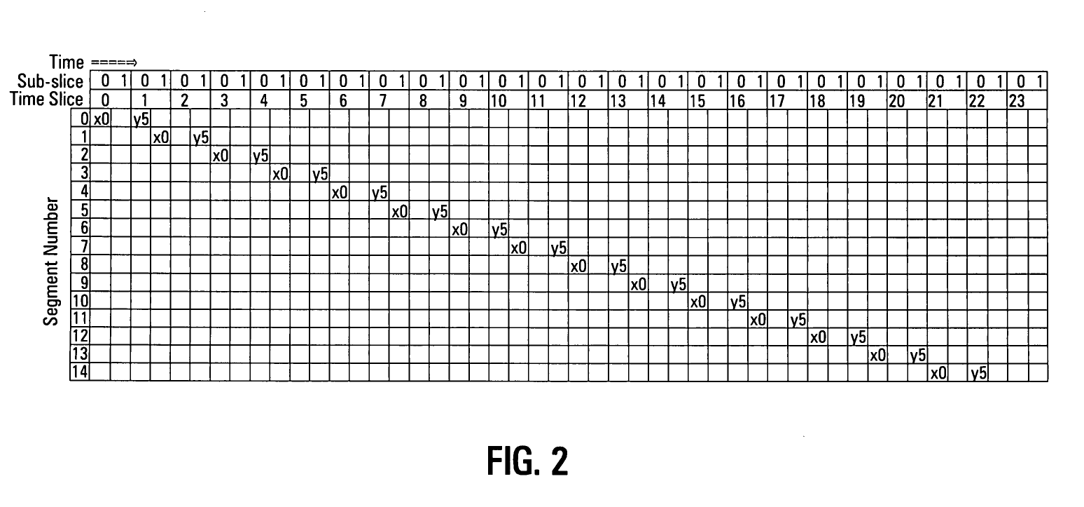

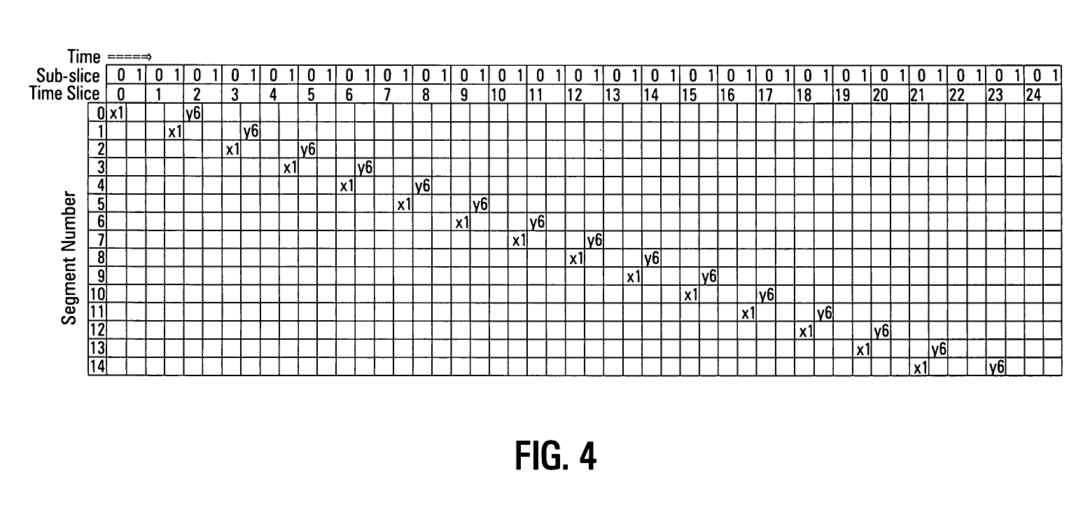

Following are definitions of terms used in conjunction with describing FIGS. 2-4: An array segment is an arbitrary group of pixel rows, e.g., 16 pixels tall by the array width, of a micro-display 120. Time slices are increments of time corresponding to the color depth of the source data. For example, displaying a single 8-bit color source on a micro-display 120 would require 2⁸−1=255 time slices that fit within a source frame time (in the case of video). 8-bit color requires 2⁸=256 digital codes to represent, but only requires 255 time slices to display because the color black (code 0) requires zero time slices of display time. The source frame time is defined as the time it takes to display all of the bits of source data. A time slice corresponds to the shortest time a color is displayed on a pixel. For one embodiment, this corresponds to the binary-weighted time the least significant bit for that color, i.e., the binary bit 0 (or the zeroth binary bit), is displayed. For a source frame time of (1/60) seconds and for three colors displayed on a singe micro-display, this is [(1/60) seconds/frame]/[(3 colors/time slice)×(255 time slices/frame)]=21.79 micro-seconds. In general, the binary-weighted display time for the Nth bit, for this example, is t_{N}=(21.79 micro seconds)×2^{N}. Sub-slices are divisions of time slices. The duration of a sub-slice enables the algorithm described herein produce short bit display times. For one embodiment, there are an even integer number of sub-slices per time slice for producing a linear display output. For another embodiment, there two sub-slices per time slice, as shown in FIGS. 2 and 4. A ripple is a data-loading cascade that proceeds up or down a portion of an array of pixels of a micro-display 120 on successive time slices autonomously from the initiation of the sequence. For example, the x0s and y5s of FIG. 2 each constitute one ripple.

FIG. 2 illustrates loading on/off x0 data and on/off y5 data during, a portion of the source frame time, according to an embodiment, where x and y correspond to arbitrary colors, such as red and green, respectively, and the numbers refer to the binary weighting (or bit level) of the data. Therefore, for example, x0 may correspond to the zeroth bit level of on/off red data and y5 the fifth bit level of on/off green data. Note that the horizontal direction of FIG. 2 corresponds to time. Therefore, FIG. 2 is displaying a portion of the total number of time slices, e.g., 23 time slices, of an entire time frame, e.g. 255 time slices. Note further that the vertical direction of FIG. 2 corresponds to a spatial extent of a portion of an entire pixel array, e.g., 14 array segments of an entire pixel array.

During time-slice 0, sub-slice 0, each pixel of segment 0 is set to on/off for x0 data. Bit zero for each pixel will only be ON if the 0-255 color description (e.g., 8-bit/color representation) is an odd value (logic HIGH), for one embodiment. During time-slice 0, sub-slice 1 nothing is loaded. The display time for the x0 data expires at the end of time slice 0, and the pixels of segment 0 can be reloaded with on/off data corresponding to another bit level and/or color at time-slice 1, sub-slice 0, such as y5 data, as shown in FIG. 2. Moreover, the pixels of segment 1 are loaded with x0 data at time-slice 1, sub-slice 1.

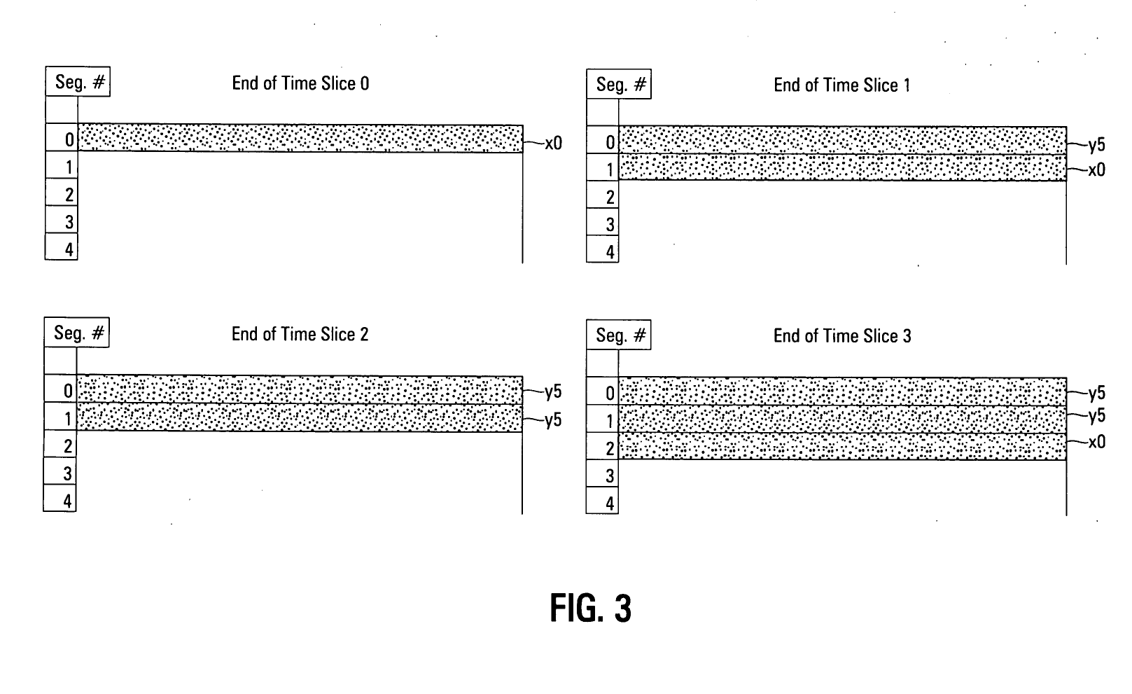

FIG. 3 shows the state of the pixels after the first four time slices, according to another embodiment. At the end of time slice 0, x0 data is displayed only on segment 0. At the end of time slice 1, y5 data has replaced the x0 data on the pixels of segment zero, and x0 data is displayed on the pixels of segment 1. Note that y5 data was loaded on segment 0 at time-slice 1, sub-slice 0, and the x0 data was loaded on segment 1 at time-slice 1, sub-slice 1, as shown in FIG. 2. At the end of time slice 2, the y5 data that was loaded on segment 0 at time-slice 1, sub-slice 0 is still displayed on segment 0, and y5 data loaded at time slice 2, sub-slice 1 has replaced the x0 data on segment 1 after the display time for the x0 data on segment 1 expired. At the end of time slice 3, the y5 data that was loaded on segment 0 at time-slice 1, sub-slice 0 is still displayed on segment 0; the y5 data loaded at time slice 2, sub-slice 1 is still displayed on segment 1; and x0 data loaded at time-slice 3, sub-slice 0 is displayed on segment 2. Note that since the y5 data is at the fifth bit level, it is displayed for 25 time slices on the respective segments.

FIG. 4 illustrates an example of loading on/off x1 data during a portion of the source frame time, e.g., the first bit level of on/off red data and on/off y6 data, e.g., the sixth bit level of on/off green data. Note that the x1 data are displayed for 2¹ time slices for each segment. The y6 data are displayed for 2⁶ time slices for each segment. Note, however, that since only a portion of the time frame is shown, the number of time slices shown in FIG. 4 would extend beyond the 22 time slices of FIG. 4 to the 2⁶ time slices.

Note that the total duration a bit is displayed on a pixel corresponds to the color intensity of the bit being displayed. Therefore, the spatial order in which segments are loaded does not matter. However, FIGS. 2 and 4 show the array segments being loaded in sequence. Only the time from when a segment is loaded until it is reloaded matters. Therefore, it is not necessary to load one segment per time-slice as the ripple progresses.

Note further that each segment is reloaded exactly on time-slice 2^{(bit#)} after the previous data load on that segment, for one embodiment. For example, each segment of FIG. 2 is reloaded with y5 data at 2⁰=1 time slice after the x0 data, and each segment of FIG. 4 is reloaded with y6 data at 2¹=2 time slices after the x1 data. This corresponds to a linear pulse modulated micro-display output versus the source data and is accomplished, for another embodiment, by staggering the sub-slices of successive time slices on which successive segments are loaded with common bit-level data. For example, segment 0 of FIG. 2 is loaded with x0 data at time-slice 0, sub-slice 0, segment 1 with x0 data at time-slice 1, sub-slice 1, segment 2 with x0 data at time-slice 2, sub-slice 0, etc. Similarly, segment 0 of FIG. 2 is loaded with y5 data at time-slice 1, sub-slice 0, segment 1 with y5 data at time-slice 2, sub-slice 1, segment 2 with y5 data at time-slice 4, sub-slice 0, etc.

Note that for one embodiment, first pixel data, e.g., x0 data, intended for a portion of a pixel array, e.g., segment 0, and having a first bit level, e.g., bit level 0, is loaded at a first time, e.g., at sub-slice 0 of time-slice 0, and is immediately displayed for a first time duration, e.g., one time slice, as shown in FIG. 2. Second pixel data, e.g., y5 data, intended for segment 0 and having a second bit level, e.g., bit level 5, is loaded at a second time, e.g., at sub-slice 0 of time-slice 1, and is immediately displayed. For another embodiment, the y5 data is displayed for at least a portion of its total display time, e.g., 2⁵ time slices before loading third pixel data, e.g., x0 data, intended for at least one other portion of the pixel array, e.g., segment 3, and having the first bit level, e.g., bit level 0, as shown in FIG. 2.

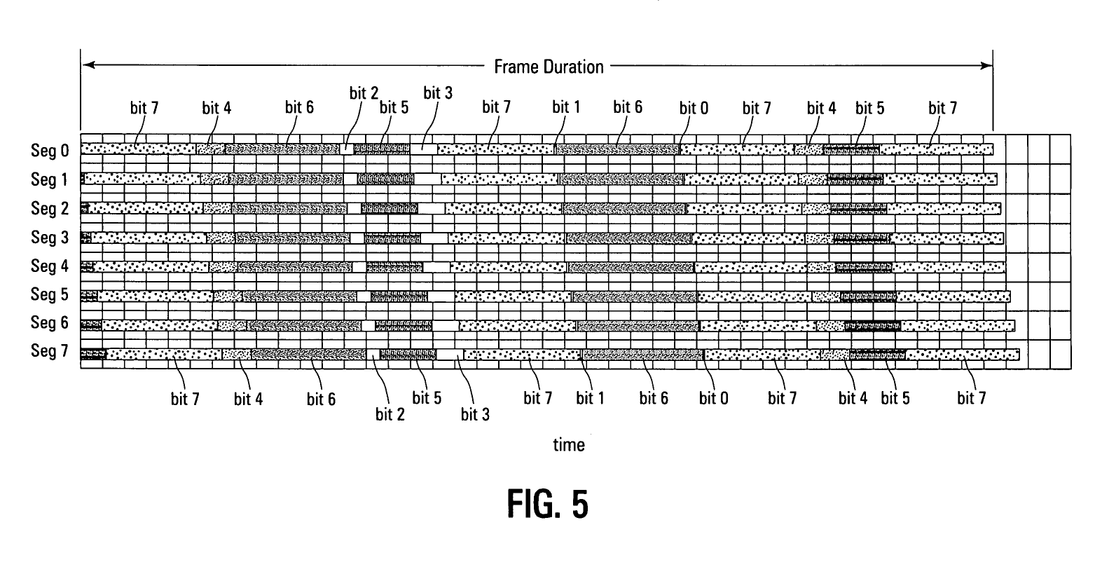

FIG. 5 illustrates an exemplary scheduling table, e.g., for an 8-bit per color representation (i.e., is 255 time slices per frame), according to another embodiment. Zeroth-bit-level data (bit 0) is displayed for 2⁰ time slices, first-bit-level data (bit 1) 2¹ time slices, . . . , and seventh-bit-level data (bit 7) 2⁷ time slices. Note that the higher order bits, e.g., those bits of order 4 and above, are displayed at more than one time during the frame duration for portions of their total display time. For example, bit 7 is displayed at four different times for 1/4 of its total display time, bit 6 at two different times for 1/2 its total display time, etc. For one embodiment, displaying pieces of the higher order bits at multiple times for portions of their total display time, enables display of the relatively short bit durations and acts to reduce display artifacts, such as flicker. Note the ripple nature of FIG. 5. That is, initiation of loading and display of successive segments are delayed in time by one slice per segment.

The information represented in FIG. 5, for one embodiment, can be contained in one or more look-up tables stored on computer-usable media 150 of FIG. 1. The one or more look-up tables define when and for how long particular bit information is displayed on a micro-display 120. For another embodiment, data can be routed to a particular micro-display 120 by changing the look-up table content. This allows multiple copies (instances) of a control algorithm to run in parallel to control different micro-displays 120, thereby enabling configurations for optical systems that require multiple micro-displays. In the case where non-native red, green, or blue color values need to be displayed, e.g., a five or six color display system, upstream color space conversion will need to be performed for various embodiments.

For one embodiment, the number of allocated sub slices may be increased by multiples of two. That is, (2×m) sub-slices may be configured, where m is greater than or equal to 1, instead of only two sub-slices provided the arrangement only allows one full segment to be loaded per sub-slice. For another embodiment, the segment size may be resized arbitrarily to shorten or lengthen the time required to load a segment. For other embodiments, more than one physical data bus may be used to load data into the microdisplay array, and a number of simultaneous segment loads equal to the number of data busses can occur.

For another embodiment, the display time for the lowest bit level data can be arbitrarily assigned to be multiple time slices long, and the display times for higher bit levels of data can be scaled accordingly. That is, the display time for the least significant binary bit may be represented by more than one time slice. The number of time slices per binary weighted display times of other bits scale respectively. For example, if the least significant bit, or bit 0, is displayed for two time slices, bit 1 would be displayed for 4 time slices, bit 2 for 8 time slices, and so on.

### CONCLUSION

Although specific embodiments have been illustrated and described herein it is manifestly intended that the scope of the claimed subject matter be limited only by the following claims and equivalents thereof.

1. A method comprising:
loading a first data bit intended for a first portion of a pixel array; and
displaying the first data bit on the first portion of the pixel array for at least a portion of its total display time before loading a second data bit intended for a second portion of the pixel array.

2. The method of claim 1, wherein the first and second data bits have different or the same bit levels.

3. The method of claim 1, wherein the total display time of the first data bit is a binary-weighted time corresponding to a bit level of the first data bit.

4. The method of claim 1 further comprises displaying the second data bit on the second portion of the pixel array.

5. The method of claim 4, wherein the second data bit is displayed for a binary-weighted time corresponding to a bit level of the second data bit.

6. The method of claim 4, wherein the second data bit is displayed for at least a portion of its total display time before loading a third data bit intended for at least one other portion of the pixel array.

7. The method of claim 6, wherein the first and third data bits have equal bit levels.

8. The method of claim 7, wherein a bit level of the first data bit is lower than a bit level of the second data bit.

9. A method of operating a projector, comprising:
loading a first data bit intended for a first segment of a pixel array at a first sub-slice of a first time slice;
displaying the first data bit on the first segment for at least the first time slice;
after displaying the first data bit, loading a second data bit intended for the first segment at a first sub-slice of a second time slice;
displaying the second data bit on the first segment; and
loading a third data bit intended for a second segment of the pixel array while displaying the second data bit on the first segment.

10. The method of claim 9, wherein loading the third data bit comprises loading the third data bit at a second sub-slice of the second time slice.

11. The method of claim 9, wherein loading the third data bit comprises loading the third data bit at a first sub-slice of a third time slice.

12. The method of claim 11 further comprises loading a fourth data bit intended for a third segment of the pixel array at a second sub-slice of a fourth time slice that occurs between the first and second time slices, wherein the fourth data bit is loaded while the first data bit is being displayed.

13. The method of claim 12 further comprises displaying the fourth data bit on the third segment while loading the second data bit.

14. A computer-usable medium containing computer-readable instructions for causing a projector to perform a method comprising:
loading a first data bit intended for a first portion of a pixel array; and
displaying the first data bit on the first portion of the pixel array for at least a portion of its total display time before loading a second data bit intended for a second portion of the pixel array.

15. The computer-usable medium of claim 14, wherein, in the method, the first and second data bits have different or the same bit levels.

16. The computer-usable medium of claim 14, wherein, in the method, the total display time of the first data bit is a binary-weighted time corresponding to a bit level of the first data bit.

17. The computer-usable medium of claim 14, wherein the method further comprises displaying the second data bit on the second portion of the pixel array.

18. The computer-usable medium of claim 17, wherein, in the method, the second data bit is displayed for a binary-weighted time corresponding to a bit level of the second data bit.

19. The computer-usable medium of claim 17, wherein, in the method, the second data bit is displayed for at least a portion of its total display time before loading a third data bit intended for at least one other portion of the pixel array.

20. The computer-usable medium of claim 19, wherein, in the method, the first and third data bits have equal bit levels.

21. The computer-usable medium of claim 20, wherein, in the method, a bit level of the first data bit is lower than a bit level of the second data bit.

22. A computer-usable medium containing computer-readable instructions for causing a projector to perform a method comprising:
loading a first data bit intended for a first segment of a pixel array at a first sub-slice of a first time slice;
displaying the first data bit on the first segment for at least the first time slice;
after displaying the first data bit, loading a second data bit intended for the first segment at a first sub-slice of a second time slice;
displaying the second data bit on the first segment; and
loading a third data bit intended for a second segment of the pixel array while displaying the second data bit on the first segment.

23. The computer-usable medium of claim 22, wherein, in the method, loading the third data bit comprises loading the third data bit at a second sub-slice of the second time slice.

24. The computer-usable medium of claim 22, wherein, in the method, loading the third data bit comprises loading the third data bit at a first sub-slice of a third time slice.

25. The computer-usable medium of claim 24, wherein the method further comprises loading a fourth data bit intended for a third segment of the pixel array at a second sub-slice of a fourth time slice that occurs between the first and second time slices, wherein the fourth data bit is loaded while the first data bit is being displayed.

26. The computer-usable medium of claim 25, wherein the method further comprises displaying the fourth data bit on the third segment while loading the second data bit.

27. A projector comprising:
a means for loading a first data bit intended for a first portion of a pixel array; and
a means for displaying the first data bit on the first portion of the pixel array for at least a portion of its total display time before loading second data bit intended for a second portion of the pixel array.

28. The projector of claim 27 further comprises a means for displaying the second data bit on the second portion of the pixel array.

29. A projector comprising:
at least one micro-display having a pixel array; and
a controller connected to the pixel array and adapted to cause the projector to perform a method comprising:
loading a first data bit intended for a first portion of a pixel array; and
displaying the first data bit on the first portion of the pixel array for at least a portion of its total display time before loading a second data bit intended for a second portion of the pixel array.

30. The projector of claim 29, wherein the method further comprises displaying the second data bit on the second portion of the pixel array.

31. The projector of claim 30, wherein, in the method, the second data bit is displayed for a binary-weighted time corresponding to a bit level of the second data bit.

32. The projector of claim 30, wherein, in the method, the second data bit is displayed for at least a portion of its total display time before loading a third data bit intended for at least one other portion of the pixel array.

33. The projector of claim 32, wherein, in the method, the first and third data bits have equal bit levels.

34. The projector of claim 33, wherein, in the method, a bit level of the first data bit is lower than a bit level of the second data bit.
